(19) United States
(12) Patent Application Publication
(10) Pub. No.: US 2018/0165422 A1
(43) Pub. Date: Jun. 14, 2018

(54) SYSTEMS AND METHODS FOR CONTROLLING THE OPERATIONAL STATE OF A MEDICAL DEVICE

(71) Applicant: Verily Life Sciences LLC, Mountain View, CA (US)

(72) Inventor: Russell Mirov, Los Altos, CA (US)

(21) Appl. No.: 15/808,584

(22) Filed: Nov. 9, 2017

Related U.S. Application Data
(60) Provisional application No. 62/431,774, filed on Dec. 8, 2016.

(51) Int. Cl. G06F 19/00; G06F 1/32

(52) U.S. Cl. CPC G06F 19/3468; G06F 1/3293

(57) ABSTRACT

The present disclosure relates to systems and methods for controlling the operational state of a medical device that has a power source. In one implementation, a method is provided for controlling the operational state of the medical device. The method may include periodically measuring at least one variable using a sensor of the medical device and determine, based on the periodically measured at least one variable, whether one or more transition conditions are satisfied. The method may also include transitioning the medical device from a low-power operational state into an active operational state when it is determined that the one or more transition conditions are satisfied, wherein the low-power operational state draws less current from the power source than the active operational state.

### REFERENCE TO RELATED APPLICATION

This application claims benefit to U.S. Provisional Application No. 62/431,774, filed on Dec. 8, 2016, the contents of which are incorporated herein by reference.

### BACKGROUND

The present disclosure generally relates to systems and methods for controlling the operational state of a medical device and thereby regulating power consumption by the device. More specifically, and without limitation, the present disclosure relates to systems and methods for automatically transitioning a medical device from a lower-power operational state into an active operational state after one or more predetermined conditions are satisfied.

A variety of medical devices exist, including those that are used for administering drugs to a patient, such as insulin. Measuring the quantity and recording the timing of a drug's administration is an integral part of many medical treatments. For many treatments, to achieve the best therapeutic effect, specific quantities of the drug may need to be injected at specific times of the day. For example, individuals suffering from diabetes may be required to inject themselves regularly throughout the day in response to measurements of their blood glucose. The frequency and volume of insulin injections must be carefully tracked and controlled to keep the patient's blood glucose level within a healthy range.

Currently, there are a limited number of products that are capable of automatically tracking drug administration without requiring a user to manually measure and record the volume and/or time of administration. Medication injection devices, such as glucose injection syringes and pens, have been developed in this area, but there is much room for improvement. For example, such devices would benefit from enhanced functionality and/or reliability.

Another challenge in developing medical devices that automatically track the drug administration is the regulation and maintenance of power, which can be particularly challenging when long storage periods exist between the time of manufacture and the time of use/sale of the device. In particular, for electronics-based medical devices that use a battery or other power source to track drug administration, it can be a challenge to conserve power over a long storage period.

To conserve a battery or other power source, one approach is to enable the device to be manually turned off or disconnected from the power source while it is in storage and to be turned back on or reconnected to the power source shortly before use. However, such an approach requires the addition of a number of structural components (buttons, switches, etc) that increase cost and complexity. Further, due to the complexity of such arrangements, incorrect usage and/or inadvertent power consumption may arise (e.g., due to the user forgetting to turn off the product or leaving it turned on for a long period).

### SUMMARY

The present disclosure generally relates to systems and methods for controlling the operational state of a medical device, such as a syringe that includes electronics for tracking drug administration. More specifically, and without limitation, the present disclosure relates to systems and methods for automatically transitioning the medical device from a low-power operational state into an active operational state after one or more predetermined conditions are satisfied.

In accordance with one example embodiment, a method is provided for controlling the operational state of a medical device that includes a power source and a sensor for measuring at least one variable. The method includes providing the medical device in a low-power operational state, and periodically measuring the at least one variable using the sensor. The method also further includes determining, based on the periodically measured at least one of the variable, whether one or more transition conditions are satisfied, and transitioning the medical device into an active operational state when it is determined that the one or more transition conditions are satisfied. In accordance with this embodiment, the low-power operational state draws less current from a power source of the medical device than active operational state.

In accordance with another example embodiment, a medical device is provided that includes a power source and a sensor for measuring at least one variable. The medical device also includes at least one processor that is configured to periodically measure the at least one variable using the sensor and determine, based on the periodically measured at least one variable, whether one or more transition conditions are satisfied. In addition, the at least one processor is configured to transition the medical device from a low-power operational state into an active operational state when it is determined that one or more transition conditions are satisfied. According to this embodiment, the lower-power operational state draws less current from the power source than the active operational state.

In accordance with yet another example embodiment, a medical injection device is provided that includes a power source, a sensor for measuring at least one variable, and a transducer that generates signals to track an injected dosage. The device also includes at least one processor that is configured to periodically measure the at least one variable using the sensor and determine, based on the periodically measured at least one variable, whether one or more transition conditions are satisfied. In addition, the at least one processor is configured to transition the medical injection device into an active operational state when it is determined that the one or more transition conditions are satisfied. Furthermore, after the transition of the medical injection device to the active operational state, the at least one processor may determine the amount of an injected dosage based on the output of the transducer.

Before explaining example embodiments of the present disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception and features upon which this disclosure is based may readily be utilized as a basis for designing other structures, methods, and systems for carrying out the several purposes of the present disclosure. Furthermore, the claims should be regarded as including such equivalent constructions insofar as they do not depart from the spirit and scope of the present disclosure.

### BRIEF DESCRIPTION OF DRAWINGS

The accompanying drawings, which are incorporated in and constitute part of this specification, and together with the description, illustrate and serve to explain the principles of various exemplary embodiments.

FIG. 1 is a perspective view of a syringe, which includes a plunger head, according to an example embodiment.

FIG. 2 is a schematic representation of an intelligent plunger head of FIG. 1, according to an example embodiment.

FIG. 3 illustrates the behavior of ultrasonic signals transmitted by the example plunger head of FIG. 1.

FIG. 4 illustrates a supply chain for the example syringe of FIG. 1, according to an example embodiment.

FIG. 5 is an exemplary graph of measurements by a temperature sensor of the syringe of FIG. 1, at various stages of the supply chain embodiment of FIG. 4.

FIG. 6 illustrates exemplary operational states and transition conditions associated with the syringe of FIG. 1, according to an example embodiment.

FIG. 7 is a flowchart of a method for controlling the operational state of a medical device, according to an example embodiment.

### DETAILED DESCRIPTION OF EXAMPLE EMBODIMENTS

Embodiments of the present disclosure provide improved systems and methods for controlling the operational state of a medical device with a power source (such as a battery), whereby the medical device is transitioned into an active operational state after one or more predetermined conditions are satisfied. In accordance with some embodiments, a sensor is used to detect when the medical device is being stored or transported, and causes the medical device to operate in a low-power operational state to conserve the power source. In some embodiments, when it is detected that the medical device is about to be used by the individual, the medical device is caused to transition to an active operational state. When the medical device is in an active operational state, a transducer may be coupled to the power source so that it can track administration of a drug by the medical device.

Reference will now be made in detail to the embodiments implemented according to the disclosure, the examples of which are illustrated in the accompanying drawings. Wherever possible, the same reference numbers will be used throughout the drawings to refer to the same or like parts.

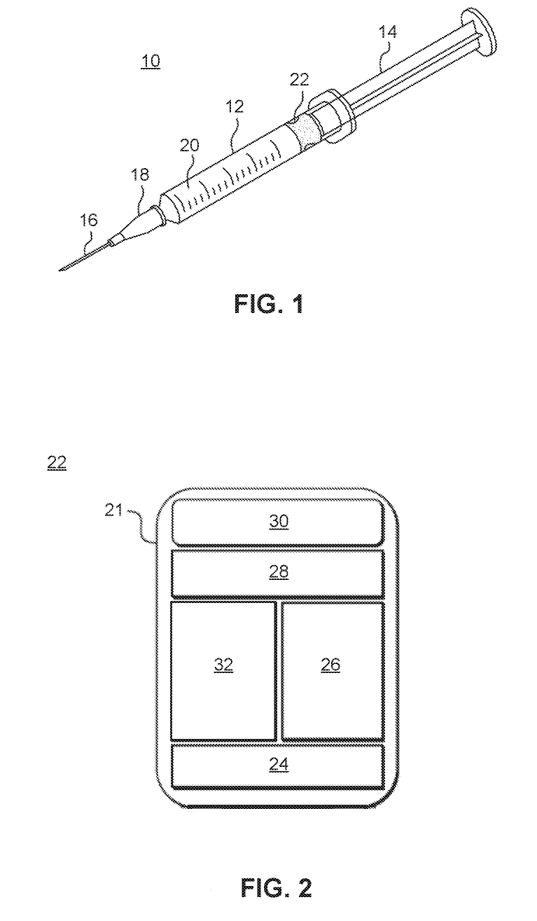

FIG. 1 shows a perspective view of a medical device in the form of a syringe 10, according to an example embodiment of the present disclosure. Syringe 10 may be designed to administer a medication 20, like insulin. As shown in FIG. 1, syringe 10 includes a barrel 12, a plunger 14, a needle 16, and a hub 18 connecting needle 16 to barrel 12. Barrel 12 may contain medication 20 and syringe 10 may be configured to dispense medication 20 from needle 16 when plunger 14 is depressed. A standard syringe usually contains a plunger head at the end of the plunger that seals the top of the barrel and forces the fluid out the needle when the plunger is depressed. The plunger head for a standard syringe is usually just a piece of molded rubber.

For syringe 10 shown in FIG. 1, the standard plunger head has been replaced with a smart or intelligent plunger head 22, consistent with embodiments of the present disclosure. As further disclosed herein, plunger head 22 includes electronics to measure and register the quantity of medication 20 administered by syringe 10. In some embodiments, plunger head 22 may be installed by withdrawing plunger 14 and removing a standard plunger head (if present) and installing plunger head 22. Further, in some embodiments, syringe 10 may be manufactured and supplied with a smart plunger head 22 preinstalled. Plunger head 22 may be sized to correspond with the size of barrel 12. For example, plunger head 22 may be formed to fit any size of syringe. For instance, plunger head 22 may be sized to fit a 1 ml, 2 ml, 3 ml, 5 ml, 10 ml, 20 ml, 30 ml, or 50 ml syringe.

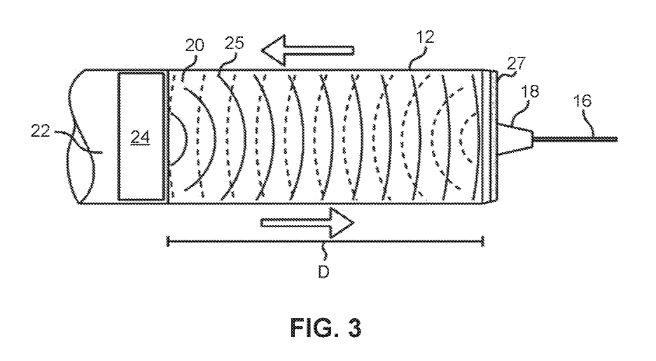

FIG. 2 is a schematic illustration of plunger head 22, according to an example embodiment. As shown in FIG. 2, plunger head 22 may include a number of components, including a transducer 24, a microcontroller 26, a power source 28, and an antenna (e.g., for near field communication (NFC)) or a transceiver 30 (e.g., for BLUETOOTH low energy (BLE) communication). In some embodiments, transceiver 30 may include or incorporate an antenna (not shown). As shown in FIG. 2, plunger head 22 may also include a temperature sensor 32. Temperature sensor 32 may be configured to measure a temperature of plunger head 22, which may be affected by the ambient temperature and/or temperature of medication 20. In some embodiments, additional or other sensors may be provided to measure one or more variables. In addition to temperature, examples of other variables include voltage, current, linear acceleration, angular acceleration, amplitude of sound, light intensity, and gas mixture. Examples of other types of sensors include an accelerometer, a gyroscope, a microphone, a light sensor, and a gas sensor.

Transducer 24 may be configured to send and receive ultrasonic signals, and generate an output reflecting, for example, the transmission and receipt of such signals. Microcontroller 26 may be programmed with instructions to control the overall operation of the components of plunger head 22. Transceiver 30 may be configured to wirelessly communicate with a remote device (e.g., a smart phone, a glucose monitor, an insulin pump, or a computer) using one or more wireless communication methods. The one or more wireless communication methods may include, for example, radio data transmission, Bluetooth, BLE, near field communication (NFC), infrared data transmission, electromagnetic induction transmission, and/or other suitable electromagnetic, acoustic, or optical transmission methods. Power source 28 may be configured to power transducer 24, microcontroller 26, transceiver 30, temperature sensor 32, and other electronical components of plunger head 22.

In some embodiments, as shown in FIG. 2, the components of plunger head 22 may be encapsulated (in part or fully) by an elastomer 21 (e.g., rubber, ethylene propylene (EPM), Nitrile (NBR), ethylene propylene diene (EPDM), polybutadiene, or polisoprene) that is shaped to define plunger head 22. In some embodiments, elastomer 21 may be formed using a molding process involving pouring of hot, liquid elastomer over the components to be encapsulated. The overall shape of plunger head 22 may be cylindrical and approximately match the interior diameter of barrel 12 of syringe 10. Moreover, plunger head 22 may include an upper end that is in contact with the distal end of plunger 14 within barrel 12 of syringe 10, and lower end that comes into contact within fluid in barrel 12 and cooperates with plunger 14 to dispense fluid from syringe 10.

Transducer 24 may include an actuator, piezoelectric element, and/or speaker-like voice coil. Further, as noted above, transducer 24 may generate and send a pressure wave or ultrasonic signal. Transducer 24 may be sized to be smaller than the inner diameter of barrel 12 and, as noted above, encapsulated in an elastomer 21. As shown in FIG. 3, transducer 24 may generate ultrasonic signals 25 (e.g., radiated sound energy waves) and send the ultrasonic signals 25 down barrel 12 toward hub 18 and needle 16. The ultrasonic signals can travel through medication 20 along the length of barrel 12 and bounce or reflect off an end 27 of barrel 12 and travel back through medication 20 to plunger head 22. The reflected ultrasonic signals can be received and detected by transducer 24. The speed of sound in medication 20 and other fluids may be a known value (and stored in memory of microcontroller 26) and thus a distance D can be calculated accurately based on the time it takes for a ultrasonic signal to travel down and back from transducer 24. As plunger head 22 is moved down barrel 12, distance D will change and by knowing the diameter of barrel 12 the volume of medication 20 dispensed may be calculated based on the change in distance D.

In some embodiments, microcontroller 26 may be attached to a printed circuit board and may include one or more processors, including for example, a central processing unit (CPU). The processor(s) may be implemented using a commercially available processor or may be a custom designed processor (e.g., an application-specific integrated circuit (ASIC)). Microcontroller 26 may include additional components including, for example, non-volatile memory (e.g., a flash memory), volatile memory (e.g., a random access memory (RAM)), and other like components, configured to store programmable instructions and data.

In some embodiments, microcontroller 26 is programmed with a set of instructions to control the operation of transducer 24 and other components of plunger head 22. For example, microcontroller 26 may be programmed with instructions to receive output signals from transducer 24 and calculate the quantity of medication 20 dispensed based on the ultrasonic signals 25 generated by transducer 24. In some embodiments, microcontroller 26 may be programmed to detect and record the reflection times of the ultrasonic signals 25. Based on the reflection times, microcontroller 26 may track and produce a time profile and/or other data reflecting the position of transducer 24 (i.e., plunger head 22). Based on the time profile of the position, microcontroller 26 may be able to identify a first distance D₁ or starting position (e.g., before medication 20 is dispensed), which may correspond with barrel 12 being filed and a second distance D₂ or ending position (e.g., after medication 20 is dispensed), which may correspond with barrel 12 being empty. Microcontroller 26 may then calculate the change in distance between D₁ and D₂ and based on the change in distance calculate the volume (i.e., amount or quantity) of medication 20 dispensed. In some embodiments, microcontroller 26 may be programmed to take into account signal delays between microcontroller 26 and transducer 24 for the calculation of distance D.

In some embodiments, a second microcontroller may be programmed with a set of instructions to control the operation of transducer 24 and other components of plunger head 22. In some embodiments, the second microcontroller may be a part of transducer 24. For example, the processor may be fabricated in the same substrate as transducer 24 so as to reduce the electrical parasitics between the processor and transducer 24. In these embodiments, the processor send calculated distance D, volume of medication 20 dispensed, and/or volume of medication 20 remaining to microcontroller 26. Plunger head 22 may transmit data (e.g., the amount of medication 20 dispensed and time and date it was dispensed) to a remote device (e.g., a smart phone, a glucose monitor, an insulin pump, or a computer) via one or more of the wireless communication methods.

Antenna or transceiver 30 may be used to communicate with a variety of remote devices (e.g., smart phones, glucose monitors, insulin pumps, computers, etc.). Plunger head 22 may transmit the information via any suitable wireless communication method. For example, in some embodiments, plunger head 22 may utilize radio data transmission, BLUETOOTH or (BLE), near field communication (NFC), infrared data transmission or other suitable method. In some embodiments, information may also be wirelessly transmitted from a remote device to plunger head 22 via antenna 30. For example, the date and time may be set by writing to microcontroller 26 via the wireless communication.

Power source 28 may be any suitable power source. For example, power source 28 may be a battery, a capacitor, or the like. In some embodiments, power source 28 may be a non-rechargeable battery that is configured to last the storage and operational life of plunger head 22. For example, in some embodiments, power source 28 may be a conventional small-sized battery (e.g., a watch battery).

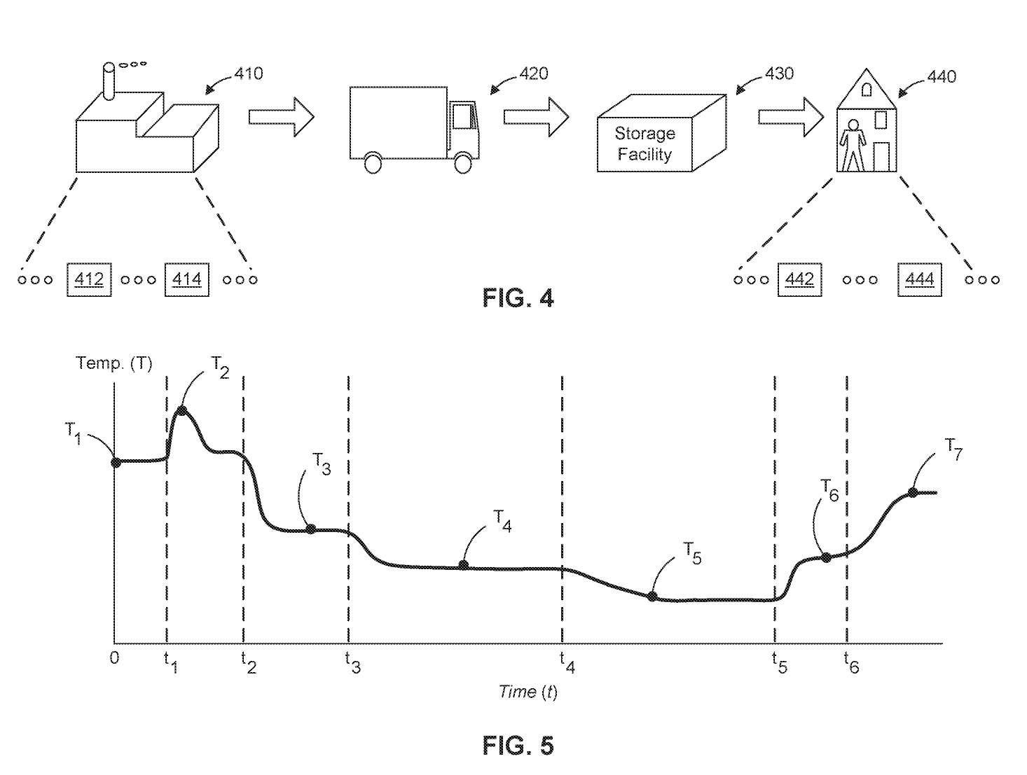

FIG. 4 illustrates a supply chain 400 for manufacturing and distributing syringe 10 with plunger hear 22 to consumers, in accordance with an example embodiment. As shown in FIG. 4, supply chain 400 may include a number of supply chain stages. For example, supply chain 400 includes a manufacturing stage 410, a distribution stage 420, a storage stage 430, and a consumer stage 440. It will be appreciated from the present disclosure that the number and arrangement of these stages (as well as related sub-stages) are exemplary only and provided for purposes of illustration. Other arrangements and numbers of supply chain stages may be utilized without departing from the teachings and embodiments of the present disclosure.

At manufacturing stage 410, syringe 10 is manufactured, assembled, and/or prepared for distribution to a storage facility. As shown in FIG. 4, manufacturing stage 410 may include a number of sub-stages. At a sub-stage 412, for example, plunger head 22 is formed using a molding process, which may involve pouring hot, liquid elastomer over the components (e.g., microcontroller 26 and temperature sensor 32) to be embedded in plunger head 22 using a mold, etc. In other embodiments, 3-D printing or another additive manufacturing process may be used to form plunger head 22 by, for example, encapsulating the components in an elastomer or other material that forms plunger head 22.

At a sub-stage 414, a fully assembled syringe 10 may be filled with medication 20. In some embodiments, medication 20 may be chilled (e.g., to about 3 degrees Celsius) prior to being drawn into syringe 10 because medication 20, such as insulin, may have a longer shelf life at lower temperatures. In some embodiments, manufacturing stage 410 may further include, for example, a sub-stage (not shown) during which plunger head 22 is attached to plunger 14 and/or a sub-stage (not shown) during which plunger 14 and/or plunger head 22 are inserted into barrel 12.

At distribution stage 420, syringe 10, prefilled with medication 20, may be transported to a storage facility by a vehicle. To preserve the efficacy and/or to prolong the shelf life of medication 20, syringe 10 may be stored in a temperature-controlled compartment of the vehicle while being transported. In some embodiments, the temperature-controlled compartment of the vehicle may be at a temperature lower than the room temperature. For example, the temperature-controlled compartment of the vehicle may be configured to be at a temperature of about 3 degrees Celsius. In some embodiments, it is contemplated that syringe 10 will be subjected to vibrations (e.g., due to road vibrations) and/or other movements (e.g., due to vehicle accelerations/decelerations) during transportation. Alternatively, or additionally, it is contemplated that syringe 10 will be subjected to various noises generated from the vehicle, as well as random noises originating from outside the vehicle. As further described below, these conditions may be detected by plunger head 22 to control the transition of syringe 10 between one or more operational states.

At storage stage 430, syringe 10 may be stored in a storage facility. For example, at storage stage 430, syringe 10 may be stored in a temperature-controlled area of the storage facility to preserve the efficacy and/or to prolong the shelf life of medication 20. The temperature of the temperature-controlled area in the storage facility may be the same as or different from the temperature of the temperature-controlled compartment of the vehicle used for transportation. It will be appreciated that, if syringe 10 is configured to continuously operate in a fully functioning operational state (i.e., an active operational state) while being stored in the storage facility, a significant portion of power stored in power source 28, if not all, would be consumed before syringe 10 is distributed to and/or used by the user.

To address the above challenges, the operational state of the syringe 10 may be controlled to consume a lower amount of power (i.e., a low-power operational state) compared to an active operational state while being stored in the storage facility (i.e., at storage stage 430). In such cases, microcontroller 26 of syringe 10 may detect when syringe 10 is being stored in the storage facility, and based on the detection, maintain syringe 10 in a low-power operational state. Subsequently, syringe 10 may be controlled to transition into an active operational state after syringe 10 leaves the storage facility, e.g., after the user receives syringe 10 and/or shortly before syringe 10 is used. As further described below, one or more predetermined conditions may be detected by plunger head 22 to control the operational state of syringe 10 as it moves into and later out of the storage facility. According to the disclosed embodiments, when syringe 10 is operating in the active operational state, it provides one or more functionalities (e.g., automatic tracking of the injected dosage and communication of such information to a remote device) that are not enabled or operational in the low-power operational state.

In some embodiments, syringe 10 may transition into the low-power operational state at an earlier stage, e.g., at distribution stage 420 or manufacturing stage 410. In such cases, microcontroller 26 of syringe 10 may be configured to detect when syringe 10 is being manufactured or transported in a vehicle, and based on this detection, maintain syringe 10 in the low-power operational state.

According to some embodiments, syringe 10, operating in the low-power operational state, may consume a lower amount of power compared to the active operational state by isolating one or more components from power source 28 or otherwise reducing power consumption. For example, syringe 10, operating in the low-power operational state, may cause a clock frequency of microcontroller 26 to become lower than the maximum clock frequency or turn off a portion of microcontroller 26. In some embodiments, syringe 10, operating in the low-power operational state, may decouple one or more components of syringe 10 from power source 28. For example, syringe 10, operating in the low-power operational state, may open a relay or switch between power source 28 and one or more components (such as transducer 24) so as to prevent current from flowing into the component(s).

In some embodiments, syringe 10 may operate in one of a plurality of low-power operational states. For example, syringe 10 may operate in a first low-power operational state where power is provided to a first subset of components of syringe 10 or in a second low-power operational state where power is provided to a second subset of components of syringe 10. The amount of power consumed in each of the low-power operational states may be the same or different.

Referring again to FIG. 4, at consumer stage 440, syringe 10 is distributed to a user. In some embodiments, consumer stage 440 may include sub-stages 442 and 444. At sub-stage 442, syringe 10 may be stored in a refrigerator owned by the user. The temperature inside the refrigerator may be the same or different than the temperature of the temperature-controlled compartment of the vehicle and/or the temperature of the temperature-controlled area of the storage facility. In some embodiments, the temperature inside the refrigerator may have a higher variability than the temperature of the temperature-controlled compartment of the vehicle and/or the temperature of the temperature-controlled area of the storage facility. At sub-stage 444, syringe 10 is removed from the refrigerator by the user, and medication 20 is ejected from syringe 10 into the user. In some cases, the user may place syringe 10 outside the refrigerator for a period of time (e.g., 10-20 minutes) before medication 20 is injected. Additionally, or alternatively, syringe 10, after being removed from the refrigerator, may be placed in a warm bath for a predetermined amount of time. The user may warm syringe 10 prior to injecting medication 20 because injecting cold medication 20 may be painful for the user.

Syringe 10 may be reused to inject the remaining medication 20 at least once after the first injection. In such cases, syringe 10 may be controlled to transition into the low-power operational state between injections. Syringe 10 may be stored in the refrigerator between the injections, and syringe 10 may transition into the low-power operational state, for example, when the change in temperature is detected. Alternatively, syringe 10 may be stored outside the refrigerator between injections, and syringe 10 may transition into the low-power operational state, for example, when the measured acceleration is below a threshold amount.

FIG. 5 is an exemplary graph 500 of the temperatures expected to be measured by temperature sensor 32 of syringe 10 at various supply chain stages (sub-stages) of supply chain 400. It will be appreciated from the present disclosure that the temperatures and timing shown in and described with respect to graph 500 is exemplary only and provided for purposes of illustration.

Between t=0 and t=t1, syringe 10 is being manufactured and is at supply chain stage 410 prior to sub-stage 412. Therefore, during this period, the measured temperature may be at the ambient temperature of the factory (T1) since temperature sensor 32 has not been embedded into plunger head 22 and remains is exposed. In some cases, the ambient temperature may be at the room temperature (i.e., 26 degrees Celsius).

Between t=t1 and t=t2, syringe 10 is still being manufactured but has moved to sub-stage 412 of manufacturing stage 410. As discussed above, sub-stage 412 may involve pouring hot, liquid elastomer over the electronics, including temperature sensor 32, to form plunger head 22. Therefore, during this period, the measured temperature may increase to a temperature (T2) that is slightly below the temperature of the liquid elastomer that is poured over the electronics. The measured temperature may subsequently decrease as the elastomer is cooled while hardening. For example, as shown in FIG. 5, the measured temperature may decrease back to T1.

Between t=t2 and t=t3, syringe 10 is at sub-stage 414 of manufacturing stage 410. At sub-stage 414, as discussed above, syringe 10 may be filled with or is being filled with medication 20. Therefore, during this period, the measured temperature may decrease to a temperature (T3) that is slightly above the temperature of medication 20.

Between t=t3 to t=t4, syringe 10 is at distribution stage 420. At distribution stage 420, as discussed above, syringe 10 may be loaded onto a temperature-controlled compartment of a vehicle. Also, as discussed above, the temperature-controlled compartment of the vehicle may be configured to be at a temperature below the room temperature so as to preserve the efficacy and prolong the shelf life of medicine 20. Therefore, as shown in FIG. 5, the measured temperature may change to the temperature of the temperature-controlled compartment of the vehicle (T4). In some embodiments, T4 may be substantially the same as T3. In such cases, T4 may be between 3 degrees Celsius and 8 degrees Celsius.

Between t=t4 to t=t5, syringe 10 is at storage stage 430. At storage stage 430, as discussed above, syringe 10 is stored in a temperature-controlled area of the storage facility. Also, as discussed above, the temperature-controlled area of the storage facility may be configured to be at a temperature below the room temperature so as to preserve the efficacy and prolong the shelf life of medicine 20. Therefore, the measured temperature may change to the temperature of the temperature-controlled area (T5). In such cases, T5 may be substantially the same as T4 or T3. In some embodiments, T5 may be between 3 degrees Celsius and 8 degrees Celsius. Additionally, or alternatively, the temperature variation at storage stage 430 may be lower or higher than or the same as the temperature variation at distribution stage 420.

Between t=t5 to t=t6, syringe 10 is at sub-stage 442 of consumer stage 430. At sub-stage 442, as discussed above, syringe 10 may be distributed to the user and stored in the user's refrigerator. Therefore, the measured temperature may change to the temperature inside the user's refrigerator (T6). In such cases, T6 may be between 3 degrees Celsius and 8 degrees Celsius. The temperature variation at sub-stage 442 may be higher than the temperature variation at prior supply chain stages, for example, because the user's refrigerator is opened frequently.

Between t=t6 to t=t7, syringe 10 is at sub-stage 444 of consumer stage 430. At sub-stage 444, as discussed above, syringe 10 may be warmed before being used by the user. Therefore, the measured temperature may be the ambient temperature of the location where the user uses syringe 10. For example, as shown in FIG. 5, the measured temperature may change to the ambient temperature at user's work place or home (T7). In some cases, T7 may be between 17 degrees Celsius and 28 degrees Celsius. In some cases, T7 may be around 23 degrees Celsius.

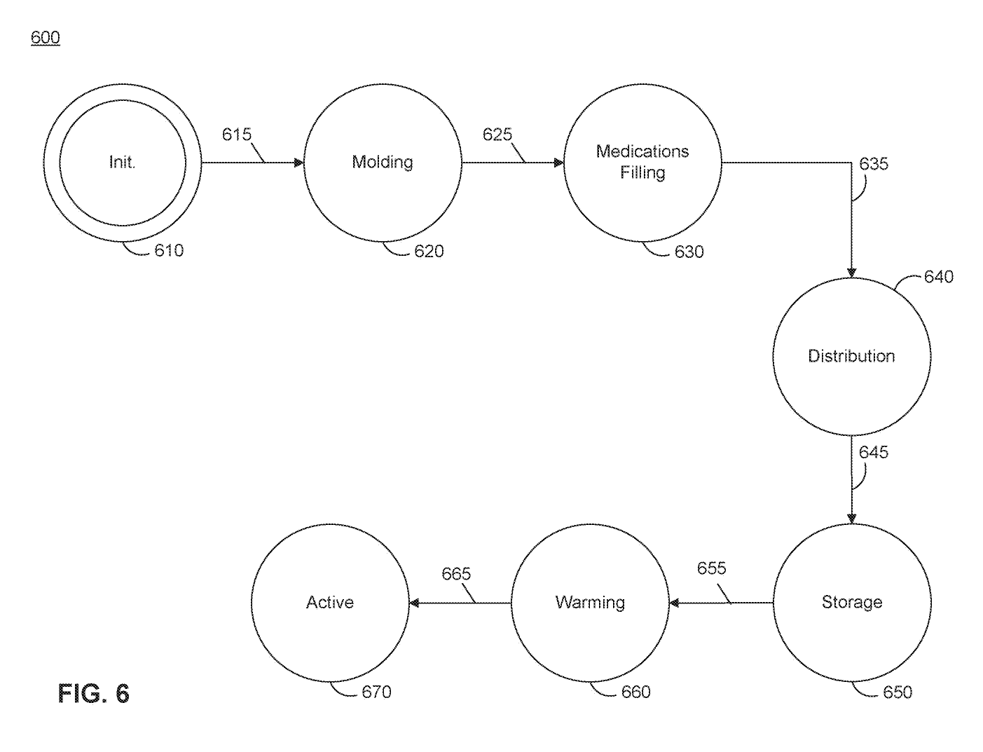

FIG. 6 illustrates a set of operational states 600 associated with syringe 10, according to an example embodiment. Each operational state illustrated in FIG. 6 may define how syringe 10 and its components behave or function. For example, an operation state may define whether and when one or more processes are executed by microcontroller 26, whether one or more components are decoupled from power source 28, and/or the clock speed of microcontroller 26. In addition, an operational state may be a low-power operational state or an active operational state, as discussed above with respect to FIG. 4.

In FIG. 6, operational states 610, 620, 630, 640, 650, 660, and 670 are shown. However, it will be appreciated from the present disclosure that the number and arrange of the operational states is exemplary only and provided for purposes of illustration. Other number and arrangement of operational states may be utilized without departing from the teachings and embodiments of the present disclosure.

According to the disclosed embodiments, syringe 10 may operate in one operational state at a given time chosen from the set of operational states 600. However, in some embodiments, syringe 10 may be associated with a plurality of sets of operational states, and syringe 10 may operate in a plurality of operational states, each chosen from a different set of operational states.

In some embodiments, microcontroller 26 may keep track of which operational state(s) syringe 10 is in (i.e., the current operational state). Furthermore, microcontroller 26, when operational, may provide control signals and/or instructions to other electronical components, such as the temperature sensor 26 and transducer 24. Additionally, or alternatively, microcontroller 26 may also execute one or more sets of instructions or programs, such as a diagnostic software, if defined by the current operational state.

According to the disclosed embodiments, syringe 10 may transition from a first operational state to a second operational state by satisfying a transition condition associated with the first operational state. In some embodiments, satisfying a transition condition may be based on one or more criteria involving a time-dependent variable, such as the measured temperature, measured acceleration, internal voltage, and/or internal timer. For example, a transition condition may be satisfied, at least in part, when the measured temperature is within a predetermined range of values for a predetermined amount of time. As another example, a transition condition may be satisfied, at least in part, when the measured temperature changes at a predetermined rate or within a predetermined range. Additionally, or alternatively, satisfying a transition condition may be based on a variance of a variable. For example, a transition condition may be satisfied, at least in part, when the measured temperature is at a predetermined temperature and has a variance that is below a predetermined level of variance. In some embodiments, a transition condition may be based on a plurality of variables. For example, satisfying a transition condition may be based on the at least two of the following measured variables: temperature, sound, acceleration, rotation, gas composition/mixture, and/or light intensity. In another example, satisfying a transition condition may be based on a comparison of at least two of the above variables.

In FIG. 6, operational state 610 is the initial state. Therefore, microcontroller 26 may be configured to transition syringe 10 into operational state 610 immediately or shortly after being powered-on or initialized. Syringe 10 is expected to be at manufacturing stage 410 when transitioning to operational state 610 because power is provided to microcontroller 26 for the first time during manufacturing stage 410. Therefore, according to the some embodiments, microcontroller 26 may perform one or more functions appropriate for manufacturing stage 410 when syringe 10 is in operational state 610. For example, while syringe 10 is at operational state 610, microcontroller 26 may execute one or more diagnostic programs to ensure that one or more components are working correctly. In some embodiments, operational state 610, may be a low-power operational state.

According to the disclosed embodiments, operational state 620 defines behavior of syringe 10 after the molding process for forming plunger head 22 is initiated at sub-stage 412 of manufacturing stage 410. Thus, when syringe 10 is in operational state 620, microcontroller 26 may perform one or more functions that are appropriate during and after the formation of plunger head 22. For example, while syringe 10 is in operational state 620, microcontroller 26 may execute a diagnostic program to ensure that one more components have not been damaged by the hot, liquid elastomer poured over the electronics. In some embodiments, operational state 620 may be a low-power operational state.

According to the disclosed embodiments, syringe 10 may transition from operational state 610 to operational state 620 by satisfying a transition condition 615. Transition condition 615 may be satisfied when syringe 10 is determined to have transitioned into sub-stage 412. For example, transition condition 615 may be satisfied, at least in part, when the measured temperature increases from T1 to T2 in a first predetermined amount of time and/or decreases from T2 to T1 in a second predetermined amount of time. As previously discussed, such changes in the measured temperature may be expected when syringe 10 transitions into sub-stage 412 because of the process for forming plunger head 22.

According to the disclosed embodiments, operational state 630 defines behavior of syringe 10 after or while syringe 10 is filled with medication 20 at sub-stage 414 of manufacturing stage 410. Thus, when syringe 10 is in operational state 630, microcontroller 26 may perform one or more functions that are appropriate while syringe 10 is being filled with medication 20 and/or after syringe 10 is filled with medication 20. For example, while syringe 10 is in operational state 620, microcontroller 26 may execute a program that calibrates transducer 30.

According to the disclosed embodiments, syringe 10 may transition from operational state 620 to operational state 630 by satisfying a transition condition 625. Transition condition 625 may be satisfied when syringe 10 is determined to have transitioned into sub-stage 414. For example, transition condition 625 may be satisfied, at least in part, when the measured temperature changes to T3 in a predetermined amount of time. As discussed above, such changes in the measured temperature may be expected when syringe 10 transitions into sub-stage 414 because, for example, medication 20 may be chilled before being drawn into syringe 10. According to the disclosed embodiments, operational state 640 defines behavior of syringe 10 after or while syringe 10 is transported to a storage facility in a vehicle at distribution stage 420. Thus, when syringe 10 is in operational state 640, microcontroller 26 may perform one or more functions that are appropriate during or after syringe 10 is loaded onto a temperature-controlled compartment of a vehicle. For example, while syringe 10 is in operational state 640, microcontroller 26 may use transceiver 30 to communicate with an inventory system accessible through a transceiver installed in the vehicle. In some embodiments, operational state 640 may be a low-power operational state. In embodiments where syringe 10 is associated with a plurality of low-power operational states, operational state 640 may be the low-power operational state consuming the lowest amount of power.

According to the disclosed embodiments, syringe 10 may transition from operational state 630 to operational state 640 by satisfying a transition condition 635. Transition condition 635 may be satisfied when syringe 10 is determined to have transitioned into distribution stage 420. For example, transition condition 635 may be satisfied, at least in part, when the measured temperature changes from T3 to T4 in a predetermined amount of time. Additionally, or alternatively, transition condition 635 may be defined such that transition condition 635 is satisfied, at least in part, when a road noise or vehicle vibration is detected using, for example, a microphone or inertial sensors. As discussed above, such changes in the measured temperature, noises, and/or vibrations may be expected when syringe 10 is loaded onto a vehicle and transitions into distribution stage 420.

According to the disclosed embodiments, operational state 650 defines behavior of syringe 10 while being stored in a storage facility at storage stage 430. Thus, when syringe 10 is in operational state 650, microcontroller 26 may perform one or more functions that are appropriate while syringe 10 is being stored in a temperature-controlled area of the storage facility. For example, while syringe 10 is in operational state 650, microcontroller 26 may use transceiver 30 to communicate with an inventory system accessible through a transceiver installed in the storage facility. In some embodiments, operational state 650 may be a low-power operational state. In embodiments where syringe 10 is associated with a plurality of low-power operational states, operational state 650 may be the low-power operational state consuming the lowest amount of power.

According to the disclosed embodiments, syringe 10 may transition from operational state 640 to operational state 650 by satisfying a transition condition 645. Transition condition 645 may be satisfied when syringe 10 is determined to have transitioned into storage stage 430. For example, transition condition 645 may be defined such that transition condition 645 is satisfied, at least in part, when measured temperature changes from T4 to T5 in a predetermined amount of time. As discussed above, such changes in the measured temperature may be expected when syringe 10 is unloaded from the vehicle and stored in the storage facility.

According to the disclosed embodiments, operational state 660 defines behavior of syringe 10 after syringe 10 has been sold/provided to a user at consumer and is being stored in a refrigerator of the user at sub-stage 442 of consumer stage 440. Thus, when syringe 10 is in operational state 660, microcontroller 26 may perform one or more functions that are appropriate while syringe 10 is in the refrigerator of the user. For example, while syringe 10 is in operational state 660, microcontroller 26 may use transceiver 30 to communicate with an inventory system accessible through a wireless router installed in the user's home.

According to the disclosed embodiments, syringe 10 may transition from operational state 650 to operational state 660 by satisfying a transition condition 655. Transition condition 655 may be satisfied when syringe 10 is determined to have transitioned into sub-stage 442 of consumer stage 440. For example, transition condition 655 may be defined such that transition condition 655 is satisfied, at least in part, when the measured temperature changes from T5 to T6 in a predetermined amount of time. In another example, transition condition 655 may be defined such that transition condition 655 is satisfied, at least in part, when the variability of the measured temperature changes. As discussed above, such changes in the measured temperature and/or variability may be expected when syringe 10 is moved from the storage facility into the refrigerator of the user (e.g., due to the difference in the temperature of the storage facility and the refrigerator).

According to the disclosed embodiments, operational state 670 defines behavior of syringe 10 after or while syringe 10 is warmed up before being injected into the user at sub-stage 444 of consumer stage 440. Thus, syringe 10 (or microcontroller 26) in operational state 670 may perform one or more functions that are appropriate after or while syringe 10 is removed from the refrigerator of the user and is warmed up before being injected into the user. In some embodiments, operational state 670 may be an active operational state, as discussed above with respect to FIG. 4. Therefore, when syringe 10 transitions into operational state 670, microcontroller 26 may begin tracking injection dosage and/or communicating such information via transceiver 30.

In some embodiments, microcontroller 26 may use transceiver 30 to pair and being communicating with the user's remote device. After the pairing of syringe 10 with the remote device, microcontroller 26 may periodically determine the volume of remaining medication 20 in syringe 10 using transducer 30 and transmit the information to the remote device. Furthermore, the remote device may be configured to log the received information and track the injected dosage. The remote device may be further configured to communicate the tracked dosage information to a third party. For example, the remote device may be configured to send the dosage information to a health care professional or to a program executing on a cloud platform to be analyzed.

According to the disclosed embodiments, syringe 10 may transition from operational state 660 to operational state 670 by satisfying a transition condition 665. Transition condition 655 may be satisfied when syringe 10 is determined to have transitioned into sub-stage 444 of consumer stage 440. For example, transition condition 665 may be defined such that transition condition 655 is satisfied, at least in part, when the measured temperature changes from T6 to T7 in a predetermined amount of time. As discussed with reference to FIGS. 5 and 6, such changes in the measured temperature may be expected when syringe 10 is removed from the user's refrigerator and warmed up before medication 20 is injected into the user (e.g., to abate pain during the injection).

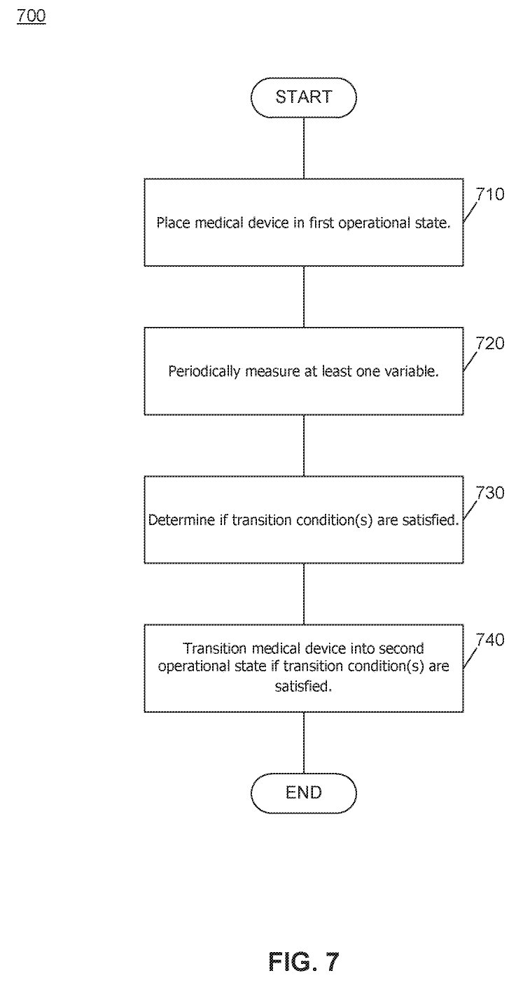

FIG. 7 illustrates a flowchart of a process 700 for controlling the operational states of a medical device, in accordance with an example embodiments. The example process 700 may be performed by at least one processor of the medical device (e.g., microcontroller 26). In some embodiments, the medical device may have at least one sensor for measuring at least one variable and a power source. In some embodiments, the medical device may further comprise a transceiver that incorporates an antenna or with a separate antenna. In some embodiments, the medical device may be an injection device such as syringe 10. As noted above, syringe 10 may include transducer 30 for generating ultrasonic signals and providing output to microcontroller 26 to determine a position of the plunger head 22 in barrel 12. In other embodiments, the medical device may be a drug dispensing pen, a medical implantable device, or any other medical device with a power source and electrical components similar to that disclosed for plunger head 22.

It will be appreciated from this disclosure that process 700 may also be implemented to control the operational state of a non-medical device. For example, process 700 may be performed to control the operational state of a mobile phone, a tablet device, a laptop, or a wearable device. In another example, process 700 may be performed by an Internet-of-Things (IOT) device. Also in some embodiments, process 700 may be implemented for a device supplementing a medical device. For example, process 700 may be performed to control the operational state of a device attached to a packaging of a medical device.

Referring again to FIG. 7 and the example of a medical device in the form of syringe 10, at step 710, the processor may transition the medical device into a first operational state. In some embodiments, the first operational state may be the initial operational state and/or a low-power operational state as discussed above.

At step 720, the processor may measure, periodically, at least one variable using a sensor of the medical device. In some embodiments, the processor may be configured to periodically measure the at least one variable approximately once one minute, once per hour, or once per day. In cases where multiple variables are measured, the processor may be configured to measure the variables at the same or different rates (e.g., a first variable of the at least one variable at a first rate and a second variable of the at least one variable at a second rate).

In some embodiments, the processor may measure a variable depending on the operational state of the medical device. For example, the processor may control a sensor to measure the variable at a first rate while the medical device is in the first operational state and at a second rate while the medical device is in a second operational state. In still other embodiments, the processor may be configured to measure a first variable using a first sensor while the medical device is in a first operational state and measure a second variable using a second sensor while the medical device is in the second operational state.

In some embodiments, the sensor may be a temperature sensor, a voltage-sensing circuit, a current-sensing circuit, accelerometer, gyroscope, microphone, light sensor, or gas sensor and configured to measure ambient temperature, voltage, current, linear acceleration, angular acceleration, sound level, light intensity, or gas concentration, respectively. In some embodiments, the variable may be a composite variable calculated based on a plurality of variables.

At step 730, the processor may determine, based on the measurement of at least one variable, whether one or more transition conditions are satisfied. In some embodiments, the determination of whether the one or more transition conditions are satisfied may be based on whether the measured variable is in a predetermined range of values for a predetermined amount of time. For example, the one or more transition conditions may be satisfied when a measured temperature is between 3 and 8 degrees Celsius, between 17 and 28 degrees Celsius, above 2 degrees Celsius, or below 40 degrees Celsius.

In some embodiments, the determination of whether the one or more transition conditions are satisfied is based on at least one of: a magnitude of change of the variable, a rate of change of the variable, and a variability of the variables. For example, the one or more transition conditions may be satisfied when the measured temperature changes by 5-10 degrees Celsius, when the measured temperature changes by a predetermined amount in the last 5 minutes, when the measured temperature is greater than 12 degrees Celsius, or combination thereof. In another example, the one or more transition conditions may be satisfied when variability of the measured temperature increases or decreases.

At step 740, the processor may transition the medical device into a second operational state after the one or more transition conditions are satisfied. In some embodiments, the satisfaction of the transition conditions may be required to follow a predetermined sequence to be deemed satisfied. For example, the medical device may transition from a first operational state to a second operational state when it is determined that a first transition condition is satisfied first and then the second transition condition is satisfied.

In some embodiments, the processor may transition the medical device into an intermediate operational state after a subset of the one or more transition conditions are satisfied in a subset of the predetermined sequence. For example, the processor may transition the medical device from the first operational state to the intermediate operational state after the first transition condition is satisfied and from the intermediate operational state to the second operational state after the second transition condition is satisfied.

In embodiments where the medical device is syringe 10, the processor may track the injected dosage using the output of transducer 30 while the medical device is in the second operational state.

In some embodiments, the processor may transition the medical device back into the first operational state after a second one or more transition conditions are satisfied in a second predetermined sequence. For example, the medical device may be transitioned into the first operational state from the second operational state after a third and a fourth transition conditions are satisfied in order.

In some embodiments, the second operational state may be the active operational state discussed above with respect to FIGS. 5-6. In some embodiments, the medical device in the first operational state (e.g., a low-power operational state) may draw less current from the power source than the medical device in the second operational state (e.g., an active operational state). In some embodiments, the medical device in the first operational state may be configured to open a relay or switch between the power source and a component and/or close the relay or switch after the medical device transitions into the second operational state.

In embodiments where the medical device further includes a transceiver, the processor may be further configured to communicate with a remote device after the transitioning of the medical device into the second operational state.

In the preceding specification, various exemplary embodiments and features have been described with reference to the accompanying drawings. It will, however, be evident that various modifications and changes may be made thereto, and additional embodiments and features may be implemented, without departing from the broader scope of the invention as set forth in the claims that follow. For example, advantageous results still could be if components in the disclosed systems were combined in a different manner and/or replaced or supplemented by other components. Other implementations are also within the scope of the following exemplary claims. The specification and drawings are accordingly to be regarded in an illustrative rather than restrictive sense. Moreover, it is intended that the disclosed embodiments and examples be considered as exemplary only, with a true scope of the present disclosure being indicated by the following claims and their equivalents.

What is claimed is:

1. A medical device, comprising:
a power source;
a sensor that measures at least one variable; and
at least one processor that is configured to:
periodically measure the at least one variable using the sensor;
determine, based on the periodically measured variable, whether one or more transition conditions are satisfied; and
transition the medical device from a low-power operational state into an active operational state when it is determined that the one or more transition conditions are satisfied,
wherein the low-power operational state draws less current from the power source than the active operational state.

2. The medical device of claim 1, wherein the at least one variable is temperature and the sensor is a temperature sensor.

3. The medical device of claim 1, wherein the at least one variable is one of a voltage across an object and a current through the object, and the sensor is one of a voltage-sensing circuit electrically coupled to the object and a current-sensing circuit electrically coupled to the object.

4. The medical device of claim 1, wherein the at least one variable is one of a linear acceleration, angular acceleration, amplitude of sound, light intensity, and gas mixture, and the sensor is one of accelerometer, gyroscope, microphone, light sensor, and gas sensor.

5. The medical device of claim 1, wherein the one or more transition conditions are satisfied when the periodically measured at least one variable is in a predetermined range of values for a predetermined amount of time.

6. The medical device of claim 1, wherein the one or more transition conditions are satisfied based on at least one of:
a magnitude of change of the periodically measured at least one variable;
a rate of change of the periodically measured at least one variable; and
a variability of the periodically measured at least one variable.

7. The medical device of claim 1, wherein the medical device further comprises a transceiver, and the at least one processor is further configured to communicate, using the transceiver, with a remote device after the medical device is transitioned into the active operational state.

8. The medical device of claim 1, wherein the medical device further comprises a transducer that generates signals to track an injected dosage.

9. The medical device of claim 10, wherein the at least one processor is further configured to determine, after the transition of the medical device to the active operational state, the amount of the injected dosage based on an output of the transducer.

10. The medical device of claim 1, wherein the at least one processor is further configured to close a switch between the power source and at least one component of the medical device after the medical device is transitioned into the active operational state.

11. A method of controlling the operational state of a medical device that has a power source, the method comprising the following operations performed by at least one processor:
periodically measure at least one variable using a sensor of the medical device;
determining, based on the periodically measured at least one variable, whether one or more transition conditions are satisfied; and
transitioning the medical device from a low-power operational state into an active operational state when it is determined that the one or more transition conditions are satisfied,
wherein the low-power operational state draws less current from the power source than the active operational state.

12. The method of claim 11, wherein the at least one variable is temperature and the sensor is a temperature sensor.

13. The method of claim 11, wherein the at least one variable is one of a voltage across an object and a current through the object, and the sensor is one of a voltage-sensing circuit electrically coupled to the object and a current-sensing circuit electrically coupled to the object.

14. The method of claim 11, wherein the at least one variable is one of a linear acceleration, angular acceleration, amplitude of sound, light intensity, and gas mixture, and the sensor is one of accelerometer, gyroscope, microphone, light sensor, and gas sensor.

15. The method of claim 11, wherein the one or more transition conditions are satisfied when the periodically measured at least one variable is in a predetermined range of values for a predetermined amount of time.

16. The method of claim 11, wherein the one or more transition conditions are satisfied based on at least one of:
a magnitude of change of the periodically measured at least one variable;
a rate of change of the periodically measured at least one variable; and
a variability of the periodically measured at least one variable.

17. The method of claim 11, wherein the medical device further includes a transceiver, and the method further comprises communicating, using the transceiver, with a remote device after the medical device is transitioned into the active operational state.

18. The method of claim 11, wherein the medical device further includes a transducer that generates signals to track an injected dosage, and the method further comprises determining, after the transition of the medical device to the active operational state, the amount of the injected dosage based on an output of the transducer.

19. The method of claim 11, wherein the method further comprises closing a switch between the power source and at least one component of the medical device after the medical device is transitioned into the active operational state.

20. A medical injection device, comprising:
a power source;
a sensor that measures at least one variable;
a transducer that generates signals to track an injected dosage; and
at least one processor configured to:
periodically measure the at least one variable using the sensor;
determine, based on the periodically measured at least one variable, whether one or more transition conditions are satisfied;
transition the medical injection device into an active operational state when it is determined that the one or more transition conditions are satisfied; and
determine, when the medical injection device is in an active operational state, the amount of the injected dosage based on an output of the transducer.
